(19) United States
(12) Patent Application Publication
(10) Pub. No.: US 2024/0257170 A1
(43) Pub. Date: Aug. 1, 2024

(54) SYSTEMS AND METHODS FOR ANOMALY DETECTION

(71) Applicant: Walmart Apollo, LLC, Bentonville, AR (US)

(72) Inventors: Akshit Sarpal, Santa Clara, CA (US); Qiwen Kang, Santa Clara, CA (US); Sherry Lijie Wan, Mountain View, CA (US)

(73) Assignee: Walmart Apollo, LLC, Bentonville, AR (US)

(21) Appl. No.: 18/102,835

(22) Filed: Jan. 30, 2023

(51) Int. Cl. G06Q 30/0201; G06N 20/20

(52) U.S. Cl. CPC G06Q 30/0206; G06N 20/20

(57) ABSTRACT

Systems and methods including one or more processors and one or more non-transitory computer readable media storing computing instructions that, when executed on the one or more processors, cause the one or more processors to perform: receiving historical marketplace information corresponding to one or more categories, wherein the historical marketplace information is for a merchant in a marketplace; determining a respective anchor for each of the one or more categories of the historical marketplace information; receiving an observed price for an item in the marketplace, wherein the observed price corresponds to an item in the one or more categories; normalizing the anchors for each of the one or more categories based on the observed price and the historical marketplace information; determining if the observed price is an anomaly based on the anchors, as normalized; and transmitting an alert to the merchant in the marketplace when an anomaly is detected. Other embodiments are disclosed.

### TECHNICAL FIELD

This disclosure relates generally to computing system management, and more particularly to systems and methods for anomaly detection.

### BACKGROUND

Marketplaces are responsible for millions of products at a time. Each of these products includes its own metadata (e.g., price, product type, etc.) that needs to be analyzed by computing systems associated with the marketplaces. However, the metadata for the products can be corrupt and can unnecessarily burden the computing systems. Accordingly, it would be desirable to have an anomaly detection system to identify and remove the corrupt metadata to improve the operation of the computing systems.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a flowchart for a method, according to certain embodiments;

FIG. 5 illustrates an exemplary table, according to certain embodiments;

FIG. 6 illustrates an exemplary machine learning model architecture, according to certain embodiments; and

FIG. 7 illustrates an exemplary flowchart for a data clustering algorithm, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and cause the one or more processors to perform: receiving historical marketplace information corresponding to one or more categories, wherein the historical marketplace information is for a merchant in a marketplace; determining a respective anchor for each of the one or more categories of the historical marketplace information; receiving an observed price for an item in the marketplace, wherein the observed price corresponds to an item in the one or more categories; normalizing the anchors for each of the one or more categories based on the observed price and the historical marketplace information; determining if the observed price is an anomaly based on the anchors, as normalized; and transmitting an alert to the merchant in the marketplace when an anomaly is detected.

Various embodiments include a method. The method can be implemented via execution of computing instructions configured to run at one or more processors and configured to be stored at non-transitory computer-readable media. The method can comprise receiving historical marketplace information corresponding to one or more categories, wherein the historical marketplace information is for a merchant in a marketplace; determining a respective anchor for each of the one or more categories of the historical marketplace information; receiving an observed price for an item in the marketplace, wherein the observed price corresponds to an item in the one or more categories; normalizing the anchors for each of the one or more categories based on the observed price and the historical marketplace information; determining if the observed price is an anomaly based on the anchors, as normalized; and transmitting an alert to the merchant in the marketplace when an anomaly is detected.

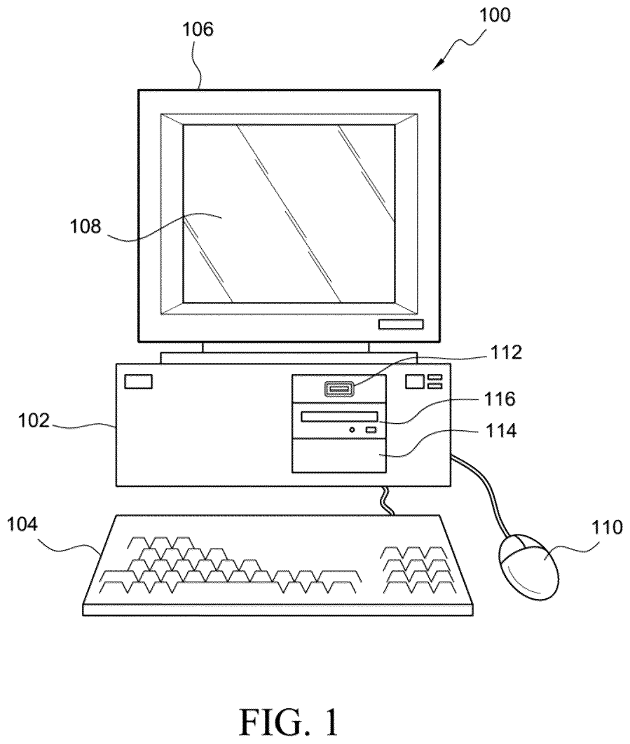

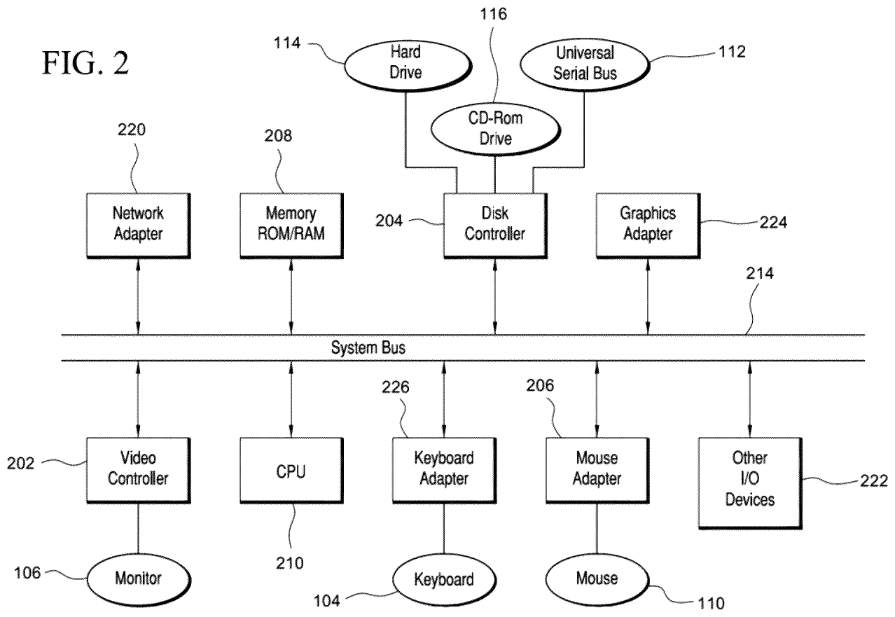

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

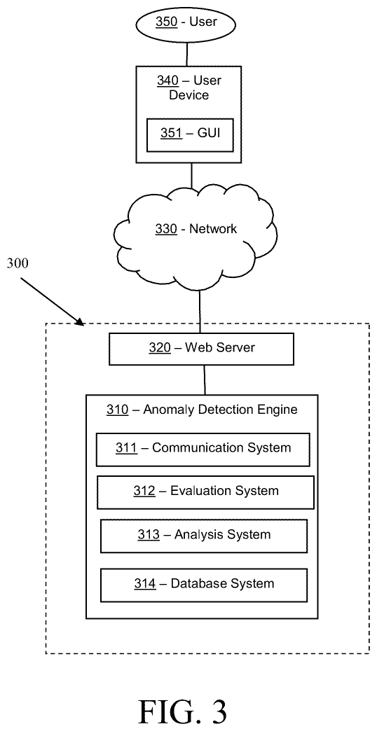

Turning ahead in the drawings, FIG. 3 illustrates a block diagram of a system 300 that can be employed for detecting price anomalies, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an anomaly detection engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Anomaly detection engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host anomaly detection engine 310 and/or web server 320. Additional details regarding anomaly detection engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with infrastructure components in an IT environment, in addition to other suitable activities. In a number of embodiments, web server 320 can interface with anomaly detection engine 310 when a user (e.g., 350) is viewing infrastructure components in order to assist with the analysis of the infrastructure components.

In some embodiments, an internal network that is not open to the public can be used for communications between anomaly detection engine 310 and web server 320 within system 300. Accordingly, in some embodiments, anomaly detection engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, anomaly detection engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to anomaly detection engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of anomaly detection engine 310 and/or web server 320. In a similar manner, the processors and/or the non-transitory computer-readable media can be local and/or remote to each other.

Meanwhile, in many embodiments, anomaly detection engine 310 and/or web server 320 also can be configured to communicate with one or more databases, such as a database system 314. The one or more databases can include historical marketplace information, user activity information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, anomaly detection engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, anomaly detection engine 310 can include a communication system 311, an evaluation system 312, an analysis system 313, and/or database system 314. In many embodiments, the systems of anomaly detection engine 310 can be modules of computing instructions (e.g., software modules) stored at non-transitory computer readable media that operate on one or more processors. In other embodiments, the systems of anomaly detection engine 310 can be implemented in hardware. Anomaly detection engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host anomaly detection engine 310 and/or web server 320. Additional details regarding anomaly detection engine 310 and the components thereof are described herein.

In many embodiments, user device 340 can comprise graphical user interface (“GUI”) 351. In the same or different embodiments, GUI 351 can be part of and/or displayed by user computer 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user computers 340. In the same or different embodiments, GUI 351 can comprise a website accessed through internet 320. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user computers 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, anomaly detection engine 310, and/or web server 320 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of anomaly detection engine 310, and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of anomaly detection engine 310, and/or web server 320. In a similar manner, the processing module(s) and the memory storage module(s) can be local and/or remote to each other.

In many embodiments, anomaly detection engine 310, and/or web server 320 can be configured to communicate with one or more user computers 340. In some embodiments, user computers 340 also can be referred to as customer computers. In some embodiments, anomaly detection engine 310, and/or web server 320 can communicate or interface (e.g., interact) with one or more customer computers (such as user computers 340) through a network or internet 330. Internet 330 can be an intranet that is not open to the public. In further embodiments, Internet 330 can be a mesh network of individual systems. Accordingly, in many embodiments, anomaly detection engine 310, and/or web server 320 (and/or the software used by such systems) can refer to a back end of system 300 operated by an operator and/or administrator of system 300, and user computers 340 (and/or the software used by such systems) can refer to a front end of system 300 used by one or more users 350, respectively. In some embodiments, users 350 can also be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

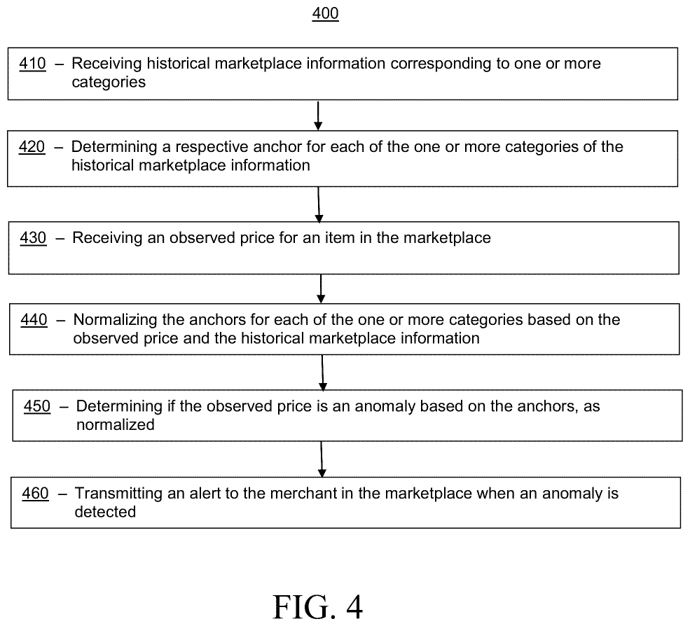

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as anomaly detection engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving historical marketplace information corresponding to one or more categories. In some embodiments, the historical marketplace information is for a merchant in a marketplace. For example, the marketplace can be an online website and the merchant can be an individual or business that is selling a product on the online website. In some embodiments, the one or more categories of the historical marketplace information can comprise at least one of the following: price updates for the item or a similar item by merchant, orders for the item or a similar item, competitor prices for the item or a similar item, 1st level marketplace price for the item or a similar item, cost for the item or a similar item, and store price of the item or a similar item. The marketplace can include a 1st level corresponding to the owner of the marketplace (e.g., Walmart.com), and a secondary level corresponding to third party merchants that sell products on the marketplace. For example, the 1st level marketplace price for a product corresponds to a price for the product that is set by the owner of the marketplace.

In many embodiments, method 400 can comprise an activity 420 of determining a respective anchor for each of the one or more categories of the historical marketplace information. For example, the method determines an anchor (i.e., weight) for each of the one or more categories of the historical marketplace information. In some embodiments, determining an anchor for the price updates for the item or a similar item by merchant comprises receiving a plurality of prices listed by a merchant for the item in the marketplace. For example, ten prices for a single item may include two prices between $1-$2, six prices between $30-$40, and two prices between $2000-$7000. In some embodiments, activity 420 can include clustering the plurality of prices into two or more buckets based on a threshold. For example, the threshold can be a range of prices. For example, a first threshold can be prices between $1 and $20, a second threshold can be prices between $30 and $100, and a third threshold can be prices above $150. In certain embodiments, the first bucket of prices can be the two prices between $1-$2, the second bucket of prices can be the six prices between $30-$40, and the third bucket can be the two prices between $2000-$7000.

In some embodiments, activity 420 can include identifying a bucket of prices from the two or more buckets that has a density of prices satisfying a condition. For example, the density of prices can be the largest number of prices available in a bucket. That is, a first bucket with one price, a second bucket with five prices, and a third bucket with one price would result in the second bucket having the highest density of prices with five prices. In some embodiments, the condition is a largest density of prices. For example, the second bucket of prices for the six prices between $30-$40 is selected because the second bucket of prices has the highest density of prices (i.e., six).

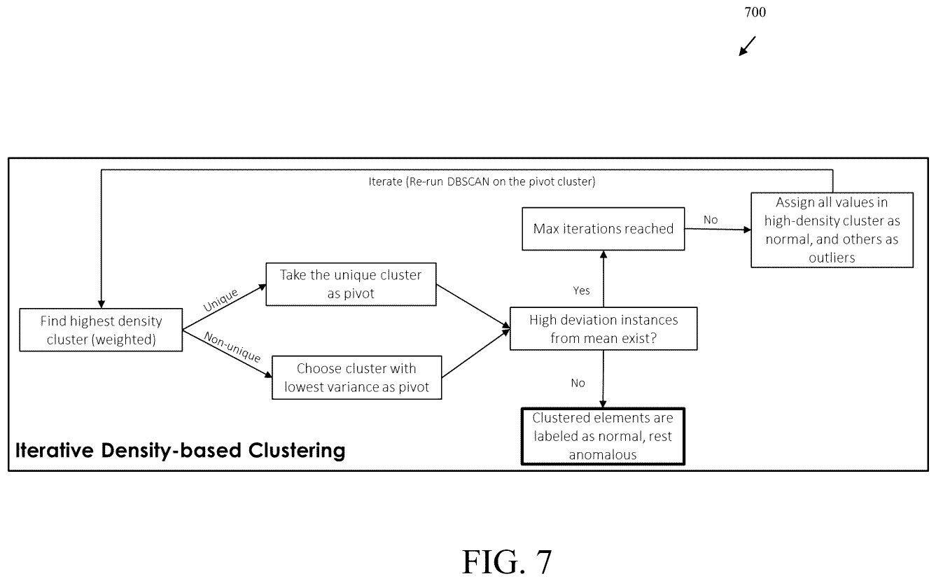

In some embodiments, activity 420 can include determining a distance metric for identifying outlying values such as ultra-high and/or ultra-low prices, as identified, based on an equation comprising:

$${d}_{ratio} = max ( \frac{{p}_{ij}}{{p}_{ik}} , \frac{{p}_{ik}}{{p}_{ij}} ) ;$$

wherein j and k are two observed price points for item i. As explained below, this equation processes historical marketplace prices for an item, and uses iterative density-based clustering to remove outliers in the historical marketplace prices. FIG. 7 shows an exemplary flowchart 700 for a data clustering algorithm, according to certain embodiments. In one example, the data clustering algorithm can be a density-based spatial clustering of applications with noise (DBSCAN) algorithm.

Returning to the equation introduced in the paragraph above and generally following the flowchart 700 in FIG. 7, in some embodiments, the distance metric is utilized to cluster the plurality of prices into two or more buckets based on a threshold. For example, the threshold can be a ratio. For example, ten prices for a single item may include two prices between $1-$2, six prices between $30-$40, and two prices between $2000-$7000. In some embodiments, activity 420 can include clustering the plurality of prices into two or more buckets based on the distance metric. In certain embodiments, the first bucket of prices can be the two prices between $1-$2, the second bucket of prices can be the six prices between $30-$40, and the third bucket can be the two prices between $2000-$7000 based on the distance metric. As discussed above, the second bucket of prices for the six prices between $30-$40 is selected because the second bucket of prices has the highest density of prices (i.e., six). In some embodiments, the second bucket of prices can be further filtered by determining a mean for the six prices and removing any additional prices that are not within a threshold value of the mean. For example, the second bucket of prices can include five prices between $31-$32 and one price of $40. In this example, the mean would be approximately 32 and the threshold value can be 5, resulting in the one price of $40 being removed. In some embodiments, the reference to non-unique in FIG. 7 corresponds to a density cluster or bucket that is the same price (e.g., six prices of $20), and unique corresponds to a density cluster or bucket that includes various prices (e.g., six prices between $20-$30). Alternatively, reference to non-unique corresponds to having more than one cluster that has a majority density, which can have unique or non-unique prices. For example, two clusters are formed and each of the two clusters includes 10 (distinct or non-distinct) price points.

In some embodiments, if the second bucket of prices still has a high variation among prices based on distance from mean value, activity 420 can include repeating the clustering step to further break down the second cluster with 6 prices into smaller clusters until there is a low variance among prices each of the final clusters. For example, the second bucket of prices can include five prices between $31-$32 and four prices of $40-$50. In this example, the variance in prices is high and the five prices between $31-32 can be a first cluster and the four prices between $40-$50 can be a second cluster. In this example, this second cluster with the four prices between $40-$50 can be identified as a minority cluster and the cluster with the five prices between $31-$32 can be identified as a majority cluster. In this embodiment, the minority cluster is removed from further processing.

In some embodiments, when determining the anchor for the price updates for the item or a similar item by merchant, activity 420 can include identifying a bucket of the two or more buckets with a lowest variance value. For example, the second bucket of prices can include five prices between $31-$32 and one price of $40. In this example, the mean would be approximately 32 and the threshold value can be 5, resulting in the one price of $40 being removed. Accordingly, the resulting variance would less than one. In this scenario, the second bucket of prices would have the lowest variance.

In some embodiments, activity 420 can include identifying a bucket of the two or more equally dense buckets (e.g. 2 buckets with five price points each) based on lowest variance. For example, in one scenario there can be a total of 10 price points, resulting in 5 price points being clustered in one bucket and the other 5 price points being clustered in another bucket. In this scenario, there are 2 equally dense buckets/clusters. In some embodiments, the variance of prices in each of the clusters can be calculated and the bucket that has lowest variance is selected. For example if the following price points are observed in bucket 1: [10, 11, 13, 14, 15] and bucket 2: [10, 11, 13, 100, 2000], then bucket 1 can be selected and all prices of bucket 2 can be removed as potential anomalies due to high variance in bucket 2.

In some embodiments, activity 420 can include determining a deviation measurement based on the distance metric. In some embodiments, the deviation measurement is a deviation from the mean of the prices and the distance metric is based on observed prices. For example, the second bucket of prices can include five prices between $31-$32 and one price of $40, and the distance metric can be a ratio of observed prices between $31-$32. In this example, the mean would be approximately 32 and deviation measurement can be 5, resulting in the one price of $40 being beyond the deviation measurement based on the mean of the prices and the distance metric. In some embodiments, the bucket of prices can satisfy the deviation measurement and retain all of the prices.

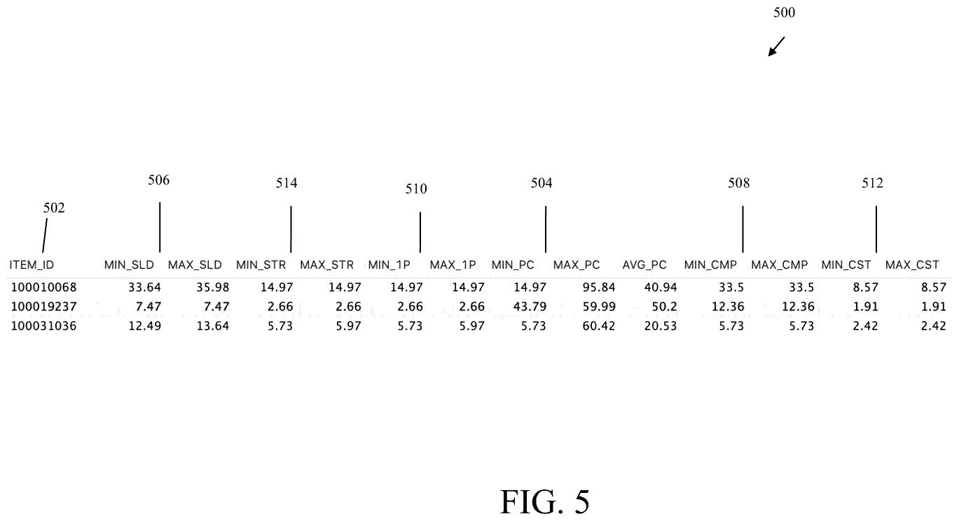

In response to the deviation measurement being within a value of the mean for the bucket of prices, activity 420 can include identifying the bucket as a processed feature set. A processed feature set corresponds to a set of values for the one or more categories of the historical marketplace information. Turning briefly to FIG. 5, a table 500 of processed feature sets is illustrated. The table 500 includes an item identifier 502 that corresponds to an item (e.g., a product), and a number of processed feature sets. In the illustrated embodiment, the table 500 includes a price (PC) processed feature set 504. The PC processed feature set 504 corresponds to the price updates for the item or a similar item by merchant category. The PC processed feature set 504 includes a minimum value, a maximum value, and an average that correspond to the prices from the bucket.

Returning to FIG. 4, the activity 420 can include determining an anchor for the orders for the item or a similar item. In some embodiments, activity 420 can include aggregating prices for the item over a period of time. For example, the period of time can be a quarter of a year, a month, or a season (e.g., Halloween, Christmas, etc.). In some embodiments, determining the anchor for the orders for the item or a similar item category can include determining a minimum price value and a maximum price value for the item over the period of time. For example, sales for an item during quarter one of the previous year can have a minimum price of $10 and a maximum of $20. In some embodiments, determining the anchor for the orders for the item or a similar item category can include predicting a future minimum price value and a future maximum price value for the item based on an output of a machine learning model. For example, the machine learning model is an Auto Regressive Integrated Moving Average (ARIMA) model and can be trained on prior aggregate prices for one or more different periods of time. In some embodiments, the future minimum price value and the future maximum price value are the anchor(s) for the orders for the item.

Turning briefly to FIG. 5, the table 500 includes a sold (SLD) processed feature set 506. The SLD processed feature set 506 corresponds to the orders for the item or a similar item category. The SLD processed feature set 506 includes a minimum value, and a maximum value that correspond to the prices from the output of the machine learning model.

Returning to FIG. 4, the activity 420 can include determining an anchor for the competitor prices for the item or a similar item. In some embodiments, determining the anchor for the competitor prices for the item or a similar item category can include receiving an array of prices for a competitor item and determining a density of prices in the array of prices based on an average of the prices in the array of prices. For example, an observed competitor price array can be [$10, $12, $11, $5, $10, $4, $11]. To determine the density of prices, a minimum price is determined, a maximum price is determined and an average for the array is calculated. In this example, density of prices is an upper-range of $8-$12 (e.g., $12 is maximum and average of the array is $8). In some embodiments, determining the anchor for the competitor prices for the item or a similar item category can include removing prices from the array of prices that are outside the density of prices to form a remaining array of prices. In this example, the competitor price array becomes [$10, $12, $11, $10, $11] after removing the prices that are outside the density of prices (e.g., the prices of $4 and $5, which could have been competitor sale prices, competitor end-of-season clearance prices, or other discounted prices). In some embodiments, determining the anchor for the competitor prices for the item or a similar item category can include identifying the anchor for the competitor prices for a similar item as the remaining array of prices.

Turning briefly to FIG. 5, the table 500 includes a competitor (CMP) processed feature set 508. The CMP processed feature set 508 corresponds to the competitor prices for the item or a similar item category. The CMP processed feature set 508 includes a minimum value, and a maximum value that correspond to the prices from the remaining array of prices.

Returning to FIG. 4, the activity 420 can include determining an anchor for the 1st level marketplace price for the item or a similar item. In some embodiments, determining the anchor for the 1st level marketplace price for the item or a similar item category can include aggregating the prices for the item that are set by the owner of the marketplace. The anchor for the 1st level marketplace price for the item or a similar item category is a minimum value and a maximum value.

Turning briefly to FIG. 5, the table 500 includes a 1^{st} level (1P) processed feature set 510. The 1P processed feature set 510 corresponds to the aggregate prices for the item that are set by the owner of the marketplace. The 1P processed feature set 510 includes a minimum value, and a maximum value that correspond to the aggregate prices for the item that are set by the owner of the marketplace.

Returning to FIG. 4, the activity 420 can include determining an anchor for the cost for the item or a similar item. In some embodiments, determining the anchor for the cost for the item or a similar item category can include aggregating the costs for the item that are determined by costs that merchants paid to acquire the item. The anchor for the cost for the item or a similar item category is a minimum value and a maximum value.

Turning briefly to FIG. 5, the table 500 includes a cost (CST) processed feature set 512. The CST processed feature set 512 corresponds to the costs that merchants paid to acquire the item. The CST processed feature set 512 includes a minimum value, and a maximum value that correspond to the aggregate costs that merchants paid to acquire the item.

Returning to FIG. 4, the activity 420 can include determining an anchor for the store price of the item or a similar item. In some embodiments, determining the anchor for the store price of the item or a similar item category can include aggregating the prices for the item when the item is sold in a brick and mortar store. The anchor for the store price of the item or a similar item category is a minimum value and a maximum value.

Turning briefly to FIG. 5, the table 500 includes a store (STR) processed feature set 514. The STR processed feature set 514 corresponds to the prices for the item when the item is sold in a brick and mortar store. The STR processed feature set 514 includes a minimum value, and a maximum value that correspond to the aggregate prices for the item when the item is sold in a brick and mortar store.

In many embodiments, method 400 can comprise an activity 430 of receiving an observed price for an item in the marketplace. In some embodiments, the observed price corresponds to an item in the one or more categories. For example, the observed price for an item can be a current price for that item that is published on the marketplace.

In many embodiments, method 400 can comprise an activity 440 of normalizing the anchors for each of the one or more categories based on the observed price and the historical marketplace information. In some embodiments, normalizing the anchors for each of the one or more categories based on the observed price and the historical marketplace information comprises using an equation comprising:

$$\begin{matrix}{x}_{i} = \frac{{f}_{MIN\_i}}{{p}_{o b s}} & ∀ i ∈ \{ sld , str , 1 p , pc , cmp , cst \}\end{matrix} ;$$

where f is the processed feature set, p_{obs} is the observed price and xᵢ is an output corresponding to an i^{th} feature. The processed feature set corresponds to the processed features sets in table 500 (FIG. 5). For example, sld is the SLD processed feature set 506, str is the STR processed feature set 514, 1p is the 1P processed feature set 510, pc is the PC processed feature set 504, cmp is the CMP processed feature set 508, and cst is the CST processed feature set 512.

In many embodiments, method 400 can comprise an activity 450 of determining if the observed price is an anomaly based on the anchors, as normalized. In some embodiments, determining if the observed price is the anomaly based on the anchors, as normalized, is based on comparing the output (xᵢ) to an output threshold. In some embodiments, the output threshold is within a range between 0.5 and 1.5. However, the output threshold can be any range based on a desired amount of price variability for an item (e.g., an observed price can be within a certain dollar amount of the historical price).

In many embodiments, method 400 can comprise an activity 460 of transmitting an alert to the merchant in the marketplace when an anomaly is detected. For example, the category anchors (e.g., processed feature sets of table 500 (FIG. 5)) may be aligned with a price for a particular item being between $30-$40 and the observed price currently being analyzed may be $3000. Based on the output (xᵢ) determined in activity 450, an anomaly exists because the observed price of $3000 will result in an output (xᵢ) outside of the range between 0.5 and 1.5, for example. Activity 460 can transmit an alert to the seller indicating that an anomaly exists for their item.

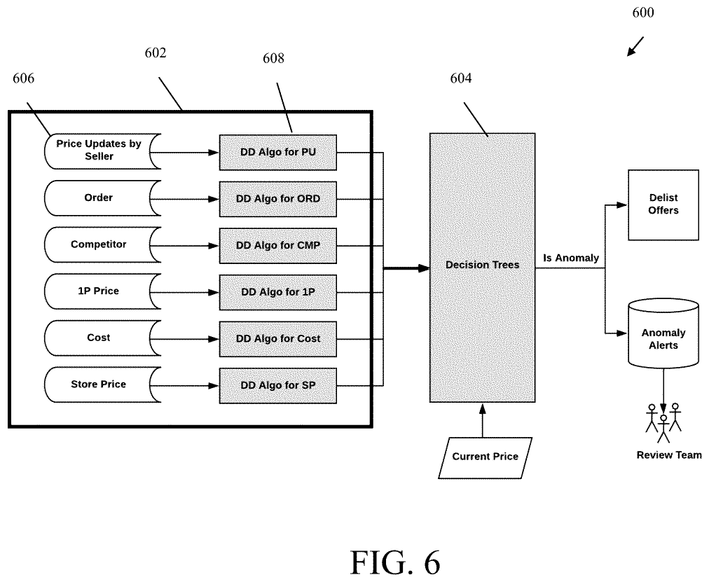

FIG. 6 illustrates an example machine learning model 600 according to certain embodiments. Machine learning model 600 can leverage historical data for price anchors like marketplace prices, competitor prices, etc., can cleanse and engineer anchors using price features, and can collect labeled data and train classification models for detection. In the illustrated embodiment, the machine learning model 600 includes a feature engine 602 that builds the features to be utilized by the decision trees 604. In some embodiments, the feature engine 602 is built according to activity 420 (FIG. 4). For example, each feature 606 corresponds to each of the historical market information categories and can include the historical marketplace information and can receive updated marketplace information. Each feature 606 and the features 606 corresponding marketplace information can be processed by a features algorithm 608. For example, the feature 606 for the store price category can include historical and current store prices for an item and the feature algorithm 608 for the store price category can aggregate the prices and determine a minimum and maximum value based on the historical marketplace information associated with the feature 606 for the store price category. This information can be populated into the table 500 (FIG. 5) as the STR processed feature set 514.

In the illustrated embodiment, the decision trees 604 can analyze the processed feature sets in the table 500 (FIG. 5) to determine if an anomaly exists for a current price of an item. In some embodiments, the decision trees 604 execute the activities 440, 450. In some embodiments, the decision trees 604 can be a Random Forest decision tree or an XGBoost decision tree.

In many embodiments, the machine learning model 600 can be a machine learning algorithm that can be trained on historical marketplace information. In some embodiments, training a machine learning algorithm can comprise estimating internal parameters of a model configured to identify anomalies in item prices. In various embodiments, a machine learning algorithm can be trained using labeled training data, otherwise known as a training dataset. In many embodiments, a training dataset can comprise all or a part of marketplace information described, created, and/or annotated in activities 410-460. In this way, a machine learning algorithm can be configured to identify price anomalies for items. In the same or different embodiments, a pre-trained machine learning algorithm can be used, and the pre-trained algorithm can be re-trained on the labeled training data. In some embodiments, the machine learning model can also consider both historical and dynamic input from an operator of the marketplace. In this way, a machine learning algorithm can be trained iteratively as data from the operator of the marketplace is added to a training data set. In many embodiments, a machine learning algorithm can be iteratively trained in real time as data is added to a training data set. In various embodiments, a machine learning algorithm can be trained, at least in part, on a single user's (e.g., user 350) interaction data or the single user's interaction data can be weighted in a training data set. In this way, a machine learning algorithm tailored to a single user can be generated. In the same or different embodiments, a machine learning algorithm tailored to a single user can be used as a pre-trained algorithm for a similar user. In several embodiments, due to a large amount of data needed to create and maintain a training data set, a machine learning model can use extensive data inputs to identify price anomalies. Due to these extensive data inputs, in many embodiments, creating, training, and/or using a machine learning algorithm configured to identify price anomalies cannot practically be performed in a mind of a human being.

Returning to FIG. 3, in several embodiments, communication system 311 can at least partially perform activity 410 (FIG. 4), and/or activity 460 (FIG. 4).

In several embodiments, evaluation system 312 can at least partially perform activity 420 (FIG. 4).

In a number of embodiments, analysis system 313 can at least partially perform activity 430 (FIG. 4), and/or activity 440 (FIG. 4), and/or activity 450 (FIG. 4).

In a number of embodiments, web server 320 can at least partially perform method 400.

In many embodiments, the techniques described herein can provide a practical application and several technological improvements. In some embodiments, the techniques described herein can provide for the operation of anomaly detection analysis and coordinating the operation amongst different computing systems.

In many embodiments, the techniques described herein can be used continuously at a scale that cannot be reasonably performed using manual techniques or the human mind. For example, processing millions of item prices within milliseconds cannot be feasibly completed by a human

In a number of embodiments, the techniques described herein can solve a technical problem that arises only within the realm of computer networks, as product price anomalies in a web-based marketplace do not exist outside the realm of computer networks.

In many embodiments, the techniques described herein can solve a technical problem in a related field that cannot be solved outside the context of computer networks. Specifically, the techniques described herein cannot be used outside the context of computer networks due to a lack of data and because the anomaly detection system cannot be performed without a computer system and/or network.

In many embodiments, the techniques described herein can provide several technological improvements. Embodiments disclosed herein utilize a data aggregation approach to incrementally add new marketplace and competitor price information as opposed to analyzing large amounts of historical data. This reduces the processing load on the anomaly detection system. Further, this ensures the machine learning model is retrained on newly observed data to ensure high precision of the system.

Accordingly, in view of all the above, embodiments of systems and methods for detecting in real-time and unpublishing in real-time high impact low-price pricing anomalies. These embodiments can identify and prevent unusual pricing for an item that falls outside of normal boundaries. As described above, these embodiments can use a stacked ensemble of machine learning and statistical models with rule-based approaches, including an iterative clustering approach for creating outlier-cleansed historical marketplace prices and also including an ARIMA model for forecasting reasonable prices based on past sales prices. Outlier removal approaches can be used for truncating low-density regions of competitor prices, and outputs from these approaches can be leveraged for a decision-tree stack. These embodiments also can combine a clustering method, a time-series model, and rule-based approaches for anchor generation, and these embodiments also can use stacked decision tree models that leverage output from the upstream anchor generation models. These embodiments allow for a better seller experience, and reduce potential loss for the seller and potentially lower commissions for the eCommerce platform provider on which the seller is selling its products and services. These embodiments also reduce potential customer dissatisfaction due to order cancellations by the seller in view of the low-price pricing anomalies.

Although systems and methods for anomaly detection analysis have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, perform functions comprising:
receiving historical marketplace information corresponding to one or more categories, wherein the historical marketplace information is for a merchant in a marketplace;
determining a respective anchor for each of the one or more categories of the historical marketplace information;
receiving an observed price for an item in the marketplace, wherein the observed price corresponds to an item in the one or more categories;
normalizing the anchors for each of the one or more categories based on the observed price and the historical marketplace information;
determining if the observed price is an anomaly based on the anchors, as normalized; and
transmitting an alert to the merchant in the marketplace when an anomaly is detected.

2. The system of claim 1, wherein the one or more categories of the historical marketplace information comprise at least one of the following: price updates for the item or a similar item by merchant, orders for the item or a similar item, competitor prices for the item or a similar item, 1^{st} level marketplace price for the item or a similar item, cost for the item or a similar item, and store price of the item or a similar item.

3. The system of claim 2, wherein determining an anchor for the price updates for the item or a similar item by merchant further comprises:
receiving a plurality of prices listed by a merchant for the item in the marketplace;
clustering the plurality of prices into two or more buckets based on a threshold; and
identifying a bucket of prices from the two or more buckets that has a density of prices satisfying a condition, wherein the condition is a largest density of prices.

4. The system of claim 3, wherein determining the anchor for the price updates for the item or a similar item by merchant further comprises determining a distance metric for the bucket of prices, as identified, based on an equation:
$${d}_{ratio} = max ( \frac{{p}_{ij}}{{p}_{ik}} , \frac{{p}_{ik}}{{p}_{ij}} ) ;$$
wherein j and k are two observed price points for item i.

5. The system of claim 4, wherein determining the anchor for the price updates for the item or a similar item by merchant further comprises:
identifying a bucket of the two or more buckets with a lowest variance value;
determining a deviation measurement based on the distance metric; and
in response to the deviation measurement satisfying a threshold, identifying the cluster as a processed feature set.

6. The system of claim 5, wherein normalizing the anchors for each of the one or more categories based on the observed price and the historical marketplace information further comprises using an equation:
$$\begin{matrix}{x}_{i} = \frac{{f}_{MIN\_i}}{{p}_{o b s}} & ∀ i ∈ \{ sld , str , 1 p , pc , cmp , cst \}\end{matrix} ;$$
wherein f is the processed feature set, p_{obs} is the observed price and xᵢ is an output corresponding to an i^{th} feature.

7. The system of claim 6, wherein determining if the observed price is the anomaly based on the anchors, as normalized, further comprises comparing the output to an output threshold, wherein the output threshold is based on a desired amount of price variability for an item.

8. The system of claim 2, wherein determining an anchor for the orders for the item or a similar item further comprises:
aggregating prices for the item over a period of time, wherein the period of time is a quarter of a year;
determining a minimum price value and a maximum price value for the item over the period of time; and
predicting a future minimum price value and a future maximum price value for the item based on an output of a machine learning model, wherein the future minimum price value and the future maximum price value are the anchor for the orders for the item.

9. The system of claim 8, wherein the machine learning model is an Auto Regressive Integrated Moving Average (ARIMA) model.

10. The system of claim 2, wherein determining an anchor for the competitor prices for the item or a similar item further comprises:
receiving an array of prices for a competitor item;
determining a density of prices in the array of prices based on an average of the prices in the array of prices;
removing prices from the array of prices that are outside the density of prices to form a remaining array of prices; and
identifying the anchor for the competitor prices for a similar item as the remaining array of prices.

11. A method implemented via execution of computing instructions configured to run at one or more processors and configured to be stored at non-transitory computer-readable media, the method comprising:
receiving historical marketplace information corresponding to one or more categories, wherein the historical marketplace information is for a merchant in a marketplace;
determining a respective anchor for each of the one or more categories of the historical marketplace information;
receiving an observed price for an item in the marketplace, wherein the observed price corresponds to an item in the one or more categories;
normalizing the anchors for each of the one or more categories based on the observed price and the historical marketplace information;
determining if the observed price is an anomaly based on the anchors, as normalized; and
transmitting an alert to the merchant in the marketplace when an anomaly is detected.

12. The method of claim 11, wherein the one or more categories of the historical marketplace information comprise at least one of the following: price updates for the item or a similar item by merchant, orders for the item or a similar item, competitor prices for the item or a similar item, 1^{st} level marketplace price for the item or a similar item, cost for the item or a similar item, and store price of the item or a similar item.

13. The method of claim 12, wherein determining an anchor for the price updates for the item or a similar item by merchant further comprises:
receiving a plurality of prices listed by a merchant for the item in the marketplace;
clustering the plurality of prices into two or more buckets based on a threshold; and
identifying a bucket of prices from the two or more buckets that has a density of prices satisfying a condition, wherein the condition is a largest density of prices.

14. The method of claim 13, wherein determining the anchor for the price updates for the item or a similar item by merchant further comprises determining a distance metric for the bucket of prices, as identified, based on an equation:
$${d}_{ratio} = max ( \frac{{p}_{ij}}{{p}_{ik}} , \frac{{p}_{ik}}{{p}_{ij}} ) ;$$
wherein j and k are two observed price points for item i.

15. The method of claim 14, wherein determining the anchor for the price updates for the item or a similar item by merchant further comprises:
identifying a bucket of the two or more buckets with a lowest variance value;
determining a deviation measurement based on the distance metric; and
in response to the deviation measurement satisfying a threshold, identifying the cluster as a processed feature set.

16. The method of claim 15, wherein normalizing the anchors for each of the one or more categories based on the observed price and the historical marketplace information further comprises using an equation:
$$\begin{matrix}{x}_{i} = \frac{{f}_{MIN\_i}}{{p}_{o b s}} & ∀ i ∈ \{ sld , str , 1 p , pc , cmp , cst \}\end{matrix} ;$$
wherein f is the processed feature set, p_{obs} is the observed price and xᵢ is an output corresponding to an i^{th} feature.

17. The method of claim 16, wherein determining if the observed price is the anomaly based on the anchors, as normalized, further comprises comparing the output to an output threshold, wherein the output threshold is based on a desired amount of price variability for an item.

18. The method of claim 12, wherein determining an anchor for the orders for the item or a similar item further comprises:
aggregating prices for the item over a period of time, wherein the period of time is a quarter of a year;
determining a minimum price value and a maximum price value for the item over the period of time; and
predicting a future minimum price value and a future maximum price value for the item based on an output of a machine learning model, wherein the future minimum price value and the future maximum price value are the anchor for the orders for the item.

19. The method of claim 18, wherein the machine learning model is an Auto Regressive Integrated Moving Average (ARIMA) model.

20. The method of claim 12, wherein determining an anchor for the competitor prices for the item or a similar item further comprises:
receiving an array of prices for a competitor item;
determining a density of prices in the array of prices based on an average of the prices in the array of prices;
removing prices from the array of prices that are outside the density of prices to form a remaining array of prices; and
identifying the anchor for the competitor prices for a similar item as the remaining array of prices.
